(19) United States
(12) Patent Application Publication
(10) Pub. No.: US 2012/0225691 A1
(43) Pub. Date: Sep. 6, 2012

(54) IDENTIFICATION MODULE WITH AN ACTIVE TAG

(75) Inventors: Olivier Desjeux, Le Landeron (CH); Pascal Gehant, Le Neuveville (CH)

(73) Assignee: Ingecom Sarl, La Neuveville (CH)

(21) Appl. No.: 13/417,396

(22) Filed: Mar. 12, 2012

Related U.S. Application Data
(63) Continuation of application No. PCT/EP2010/063413, filed on Sep. 13, 2010.

(30) Foreign Application Priority Data
Sep. 14, 2009 (CH) 2009CH-1418
Jan. 28, 2010 (CH) 2010CH-0106

(51) Int. Cl. H04B 1/40

(52) U.S. Cl. 455/558

(57) ABSTRACT

Identification module for mobile equipment, containing the contacts to interface with the said mobile unit and an active tag built with a transceiver integrated circuit and a slotted dipole antenna. The SIM card includes also its own crystal oscillator used as a time-base for the active tag.

This application is a continuation of International application PCT/EP2010/063413 filed on Sep. 13, 2010, the contents of which is hereby enclosed by reference. It claims priority from Swiss patent applications CH09/001418 filed on Sep. 14, 2009, the contents of which is hereby enclosed by reference, and CH10/00106 filed on Jan. 28, 2010, the contents of which is hereby enclosed by reference.

### TECHNICAL FIELD

The current invention relates to a SIM card provided with an active tag.

### RELATED ART

The mobile phones often use an identification card like a SIM card on the GSM or USIM on UMTS networks for the identification of the users.

Mobile phones fitted with a tag for short range identification are also known; an example is described in US patent application US2005017068. In this document, the tag is a passive tag deriving its energy from the radiofrequency signal of the reader. The range is necessarily limited.

WO06039946 describes another system as well as different applications for a system combining an RFID tag with a SIM card.

Several documents describing a RFID tag inserted inside a SIM card rather than inside a telephone are also known. This allows for an identification of the card and of the user even if the mobile phone is changed; Also, the spread out of this technology for a mobile network operator is faster since the tags can be provided together with the SIM cards without replacing the user's mobile phone.

US2009036166 describes an element in which a SIM card and a smart card which is using certain functionalities of the SIM card. The tag antenna is however not included inside the card and the connection with this antenna, as well as its insertion inside various models of mobile phones is somehow cumbersome.

DE102004046845A1 describes a card that can be used as a transport ticket and includes a double interface to operate simultaneously as a SIM card and as a tag. This document however doesn't provide any description of the antenna integration inside the card.

US2007/0281549 describes a SIM card with and RFID tag on the same PCB, and contacts for an external antenna. The assembly between the SIM card and the external antenna needs a volume larger than the one of the SIM card by its own, and can therefore be difficult to integrate inside existing mobile equipment.

One of the purposes of the invention is to offer a SIM card able to communicate over a long range using radiofrequency transmission, even when the SIM card is installed inside the mobile phone.

Another purpose is to offer a SIM card adapted for applications such as automatic ticketing or other applications described for example in the patent application DE102004046845A1.

Another purpose is to offer a solution to integrate the antenna inside a SIM card with production prices compatible with mass production, still with a quality of transmission good enough to cover a few meters range.

EP1777781 describes a GPS receiver antenna included inside a SIM card. This antenna is not adapted to the active tag; moreover, it requires a specific dielectric material that raises tremendously the production cost of the card.

According to the invention, those targets are achieved with an identification module for mobile equipment, comprising a set of contacts for connecting it to a mobile equipment, and an integrated circuit for the purpose of transmission-reception with a dipole antenna. The choice of a dipole antenna enables the integration of the transceiver on the same module as the one of the SIM card, which represents therefore a rigid single unit in the format of a standard SIM card that can be integrated inside any conventional mobile equipment that has a standard interface for SIM cards.

In a preferable embodiment the antenna structure is based around a resonating slot for a good quality antenna inside the limited volume of the overall module.

### DESCRIPTION OF THE DRAWINGS

The invention will be better understood with the help of the description of the realization mode and the associated figures which show:

FIG. 1 a view of a module according to a first embodiment of the invention.

FIG. 2 a top view of a module according to a second embodiment of the invention.

FIG. 3 a view of the antenna below the connector in a third embodiment of the invention.

FIG. 4 a view of the connector on the opposite side of the antenna according to a third embodiment of the invention.

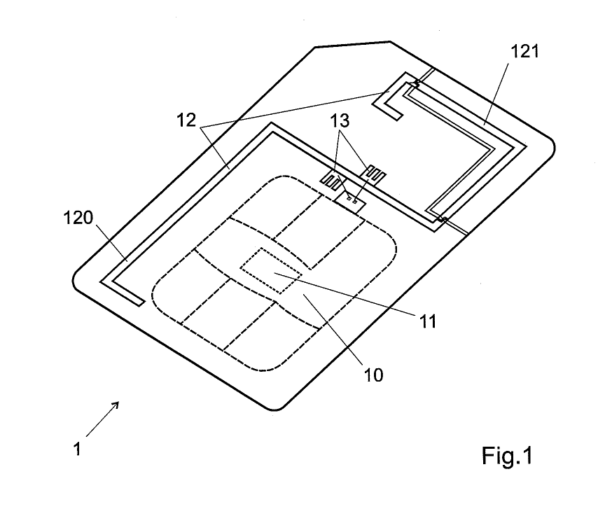

### PREFERRED EMBODIMENTS OF THE INVENTION

The SIM card includes a standard SIM or USIM processor 11 and an integrated transceiver (sender and emitter) circuit in CMOS technologie that does the active tag function. The transceiver IC communicates within the standard ISM 2.45 GHz band for example; as non limitating example purpose, the Nordic nRF2401 circuit can be used. Other frequencies, including within the 4.5 GHz range or above can also be used. An ultra wide band (UWB) modulation can also be used.

According to a new aspect, and independently from the other features of the solution, the SIM card integrates a crystal used to generate the signal modulated by the active tag. This tag doesn't use the clock signal supplied by the mobile equipment in order to remain independent of the stability problems incurrent from this clock signal. The invention thus also relates to a subscriber's identification card comprising an electronic tag, an antenna as described within this document, or a different antenna, as well as a crystal oscillator used as a timebase generator to generate the carrier frequency of the tag.

In a preferred embodiment, the active tag is powered by the stabilized voltage of the mobile equipment, and supplied to the active tag via the contacts of the SIM card. In a different embodiment it is also possible to integrate an autonomous power supply inside the SIM card in order to use the active tag even when the mobile unit is not powered up.

In yet another embodiment, the active tag is powered directly by the battery of the mobile equipment, therefore bypassing the processor of this equipment, Since the voltage required for the active tag circuit is below the voltage required for the mobile equipment, the operational lifetime of the tag is longer than the one of the mobile equipment, even when the available voltage from the battery is not sufficient to run the mobile unit's processor or when this processor is off or in standby mode.

The tag's circuit can preferably be mounted on top of the processor of the SIM in order to avoid the usage of additional space on the card. Both circuits communicate with each other preferably by the mean of of a synchronous three wire interface (CK, In, Out). The firmware of the SIM processor is preferably reprogrammed in order to generate and receive the SPI signals on three terminals of the processor.

In another embodiment the SIM processor and the transceiver integrated circuit are combined within one single chip; this embodiment is more adapted to a mass production batch but requires a total redesign of the SIM processor for each tag adaptation.

The transceiver integrated circuit adapts preferably it's transmit power automatically after having measured the amplitude of the signal received by the reader, and/or as a function of instructions received by the reader. This solution avoids transmitting with a power above the reader's required level, which allows improving the confidentiality, reducing the energy consumption and keeping constant the communication range.

The transceiver integrated circuit uses preferably a GFSK modulation to communicate with the remote RFID reader. The reception sensitivity is preferably equal or better than −85 dBm.

The transceiver integrated circuit is preferably in slave mode under the supervision of the SIM processor programmed subsequently; the transceiver integrated circuit includes essentially the analog transmit and receive elements, and a minimum of programmable digital units. The management of the data exchange with the RFID reader, the coding and decoding, etc, are preferably handled by the SIM processor.

The transceiver integrated circuit can be placed in sleep mode by the SIM processor when his usage is not required; the consumption is then in the range of one micro-ampere. It is woken up for example with a radio-frequency signal tuned on the reception circuit, or periodically as a reply to certain events by the SIM processor. On the other hand, the transceiver integrated circuit can also be used to wake-up the SIM card, the mobile equipment, or some of its functions when the components are in stand-by mode or when a wake-up signal is received.

The user identification used by the active tag is preferably the same as the IMSI identification of the cellular network; The mobile subscriber is therefore identified the same way on the RFID network and on the mobile network. The ciphering circuit of the SIM card can preferably be used for the identification and the ciphering de-ciphering of data received or sent by the active tag. A different identity, stored in the tag itself, can however be used for the identification of the active tag.

The tag antenna 12 is built on a single face of a substrate, preferably on the face opposite to the contacts 10. The substrate is thin in order to limit the production costs of the tag. The external dimensions of the tag are preferably those of a standard Plug in card in the ID-000 Format, possibly in the smaller Mini-UICC SIM-Format.

The antenna structure is massively metallic and based around a resonating slot, allowing therefore a greater immunity against the proximity of metallic elements, incurring when the SIM card is within a mobile phone. The currents within the antenna are circulating around the slot in opposite direction, so that the radiating structure of the slot is opposite to the one of a wire.

The antenna presents an electrical symmetry with an asymmetrical geometric structure.

The electromagnetic fields of the radio signal are received on both planes of the symmetrical structure, which surface is relatively important in order to minimize the influence of the neighbouring metallic masses around the SIM card.

The antenna geometry is such that it preserves the necessary surface for the electronic components of the SIM card, in particular the crystal and the electronic integrated circuit(s) 10 on the card.

The ground planes are inverted at the place where the flowing currents are inducing an electrical field opposite to the direction of the main field, in order to re-enforce the main electrical field vector in the far field. The ground plane inversion is done by cutting out the main plane at the place where the currents are flowing in opposite to the main direction. The inversion is done by a simple wiring while bonding the integrated circuit.

The important inductivity resulting from this structure is compensated by two series capacitors 13 of low value directly on the substrate at the feed points of the circuit. The network adaptation done without any discrete components provides an optimization of the production costs.

The antenna is thus preferably a dipole antenna; one first part 120 of the dipole uses a first electromagnetic path, while the other part 121 of the dipole uses a second electromagnetical path almost symmetrical to the first path, and with comparable impedance.

If a specific dielectric should be used for the antenna, a ceramic dielectric material would be used, and/or a dielectric material applied with PVD deposition.

The influence of the contacts 10 of the SIM card relative to the overall electromagnetic radiating structure is reduced since the contacts are integrated inside the general ground plane of the antenna's structure. This way they do not interfere with the radio-electric model, just like the neighbouring metal elements of the mobile phone.

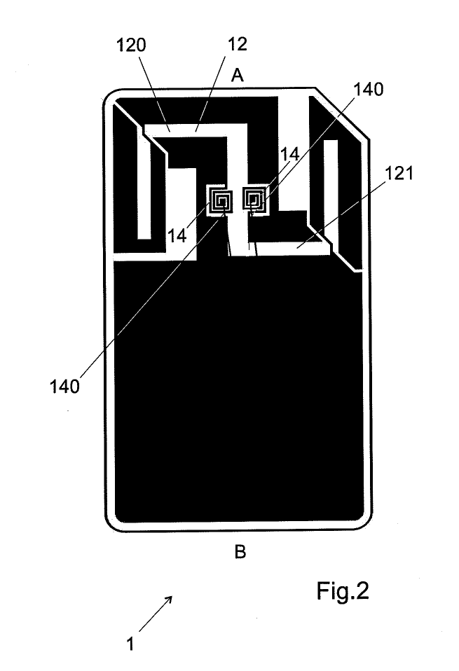

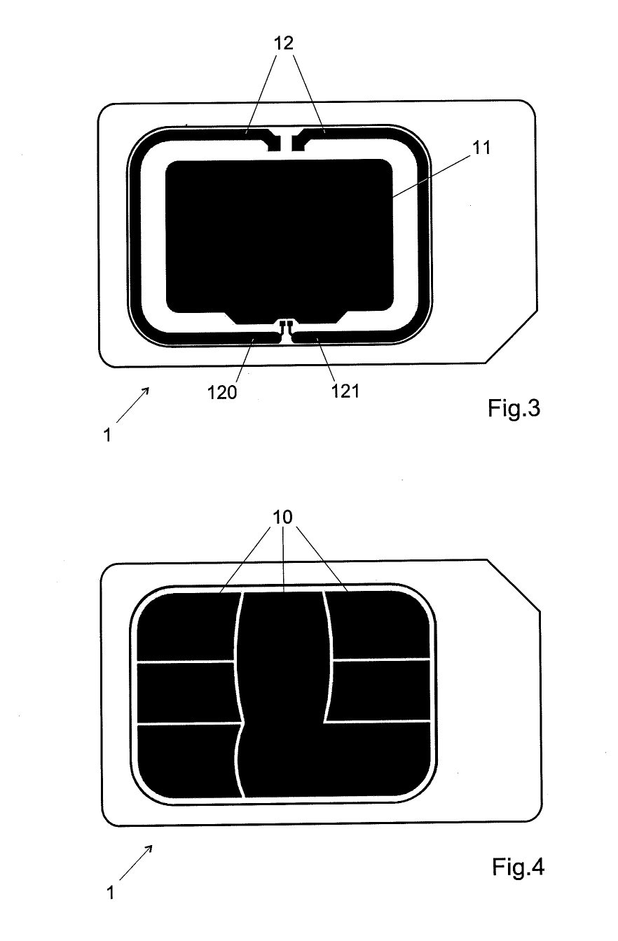

In another embodiment of the invention described on FIG. 2, the active part of the antenna 12 that transmits and receives the largest part of the radiation is focused on the extremity A of the SIM card opposite to the one with the contacts. The other extremity B of the SIM card is provided with contacts on one side. The distance between the dipole at extremity A and the contacts at extremity B enables a reduced influence of the connector's influence, and in particular also a reduced influence of the metal strap holder, often used to hold the contacts 10 of the SIM card on in its slot.

Within this particular embodiment, the dipole is made up of a slot (non metal zone that forms a white “2” on the figure, and around which the currents are flowing. The metal zone around the slot 120, 121 comprises a large ground plane at extremity B that covers this metal strap holder and the contacts. The influence of the ground plane is taken into account during the conception of the antenna, and reduces the influence of the contacts and of the metal strap holder.

Inverting the ground plane at two locations around the dipole 120, 121 allows an addition of the antenna currents, instead of a substraction. The currents that flow around those two slots are injected from the centers and the extremity of two inductors 14, notably trough bonding wires 140. Those two inductors 14 are used for a network adaptation and for compensation the electrical length of the antenna which is below the optimal length to match the resonance. The inductors are preferably added at the connection point of the circuit 11 with the antenna.

The inductors 14 are in this example made up of metallic area in the same plane and the same layer than the antenna. This solution that doesn't need any tuning in production has also the advantage to be present a reduced sensitivity to dimension or shape variations brought by the production process; the resonance impedance is therefore much less dependent on the process variations than the usage of discrete components. Discrete inductors can nevertheless also be used with the other embodiments in order to match the impedance.

In another embodiment described on the drawings 3 and 4, the dipole takes place on the SIM module's periphery. This embodiment doesn't exhibit the characteristics of a resonating antenna and therefore matches only the requirements of a short range communication, typically 5 to 10 cm, for access control and/or micro-payment applications for example.

The antenna dimension, limited to the dimension of the SIM module, allows using the conventional production means already in place within the SIM card industry, and therefore to reach immediately a production at optimized costs.

1. Identification module for a mobile equipment, said identification module comprising:
contacts to connect said identification module to said mobile equipment;
an integrated transceiver circuit; and,
a dipole antenna,
wherein said dipole antenna is based on a resonating slot.

2. The identification module of claim 1 wherein said antenna comprises:
ground planes comprising a main ground planes; and,
a cut-out of said ground plane at the place where currents flowing in said ground planes are generating an electrical field in opposition to a main electrical field for doing an inversion of said main ground plane.

3. The identification module of claim 2 comprising bonding wires for doing said inversion of said main ground plane, said bonding wires being also connected to said integrated circuit.

4. The identification module of claim 1 in which the antenna structure is based around a wired dipole structure.

5. The identification module of claim 4 in which the antenna presents an electrical symmetry, with an asymmetrical geometric structure.

6. The identification module of claim 4 comprising two series capacitors placed at feed points of the circuit for compensating the inductivity of said antenna.

7. The identification module of claim 6 wherein said two series capacitors are embedded into the substrate of said identification module.

8. The identification module of claim 1 comprising at least one inductance mounted on the substrate of said identification module for compensating the impedance of said antenna.

9. The identification module of claim 1 comprising two extremities:
the first said extremity being provided with said contacts; and,
said antenna being disposed at the other said extremity for reducing the influence of said contacts on said antenna.

10. The identification module of claim 1 including a crystal oscillator.

11. The identification module of claim 10 wherein said crystal oscillator is a quartz oscillator.
